(19) United States
(12) Patent Application Publication
(10) Pub. No.: US 2016/0101934 A1
(43) Pub. Date: Apr. 14, 2016

(54) WASTE CONTAINER

(71) Applicant: OPTISYS AS, Tromsø (NO)

(72) Inventor: Nicolai Kulseng-Varmedal, Tromsø (NO)

(21) Appl. No.: 14/787,693

(22) PCT Filed: Apr. 28, 2014
(86) PCT No.: PCT/IB2014/061047

§ 371 Date: Oct. 28, 2015

(30) Foreign Application Priority Data
Apr. 29, 2013 (NO) 20130580

(51) Int. Cl. B65F 1/06

(52) U.S. Cl. CPC B65F 1/06; B65F 2220/1063

(57) ABSTRACT

A waste container for supporting a waste bag, the container having a flat-packed state and an erected state. In the erected state, the container includes an outer housing and an insert. The outer housing includes walls and a bottom, and an upper end of the outer housing includes an upper edge that forms a top opening of an upper compartment. The insert is provided for placing inside the outer housing. The insert includes at least two spacers and a top, and the spacers project downward at right angles from the top towards the bottom such that the spacers cause the top to be held at a distance above the bottom, thereby forming a lower compartment. The outer housing includes a locking means for locking the insert inside the housing. The insert further includes a slot located in the top.

### TECHNICAL FIELD

The present invention relates to a waste container for supporting a waste bag. The present invention also relates to a system for storing waste.

### BACKGROUND OF THE INVENTION

A whole host of containers for supporting a waste bag and different systems for storing waste are known. They are used together with waste bags of different types, where the waste bag is folded over an upper edge of the container. When the waste bag is full, the top of the bag is tied together and the bag is removed, whilst a new bag is placed in the container.

The disadvantage of such containers made of rigid materials is that they must at regular intervals be washed because of leakage from the bags etc. It is therefore desirable to be able to make such containers of a recyclable material, so that they can be thrown away at regular intervals. One of the objects of the present invention is to provide such a container that is made of a recyclable material, such as paperboard, cardboard, plastic or the like.

It is also an object of the present invention that the container should take little space during transport so as to make the actual transport more economical and environmentally friendly. It is therefore an object that the container is foldable, that is to say, that it can be transported in a flat-packed state to the site of use. Here it is erected from its flat-packed state into an erected state. After use, the container can be packed flat again for transport to recycling.

It is further an object of the invention that the container is easy to erect and that it is also easy to use.

Such containers are often kept in a cupboard in the kitchen, typically in the cupboard under the sink. In particular in areas where waste must be sorted (for example, that paper, cardboard, plastic, food waste and other waste must go in separate bags), this means that several containers have to be placed side by side in a small space. It is an object of the invention that the container should help to make it easy to organise several containers next to each other in a small space. It is further an object to provide a system for storing waste, where it is easier to put in new bags as they need to be replaced using new bags from a roll of bags.

### SUMMARY OF THE INVENTION

The present invention relates to a waste container for supporting a waste bag, the container having a flat-packed stated and an erected state, wherein the container comprises:
an outer housing comprising walls and a bottom, where an upper end of the outer housing comprises an upper edge that forms a top opening of an upper compartment;
an insert for placing inside the outer housing, the insert comprising at least two spacers and a top, the spacers projecting downward at right angles from the top towards the bottom such that the spacers cause the top to be held a distance above the bottom, thereby forming a lower compartment;
wherein the outer housing comprises a locking means for locking the insert inside the housing; and
wherein the insert comprises a slot located in the top.

In an aspect, the top and the spacers in the flat-packed stated are provide as a flat cardboard sheet or a flat plastic sheet, where the spacers are foldable with the aid of fold lines in the cardboard or plastic sheet.

In an aspect, the top and the spacers in the flat-packed state are provided as a box with an automatic bottom.

In an aspect, the spacers comprise perforated tear lines for tearing off parts of the spacers.

In an aspect, the outer housing in its erected state has the form of a rectangular prism and in its flat-packed form is provided with an automatic bottom.

In one aspect, the locking means comprises two parallel cuts in a corner between two walls, where an area formed by the walls between the cuts is pressable into the upper compartment.

In an aspect, the walls each comprise a folding extension that is folded down on the outside of the outer housing in the erected state for reinforcement of the upper edge.

In an aspect, the spacers cause the top to be held substantially parallel to the bottom.

The present invention also comprises a system for storing waste, comprising: a waste container as described above and roll of waste bags located in the lower compartment when the waste container is in its erected state, where an outermost waste bag of the waste bag roll is provided through the slot in the top of the insert and is further folded over the edge of the outer housing.

### DETAILED DESCRIPTION

Embodiments of the invention will now be described with reference to the attached drawings, wherein:

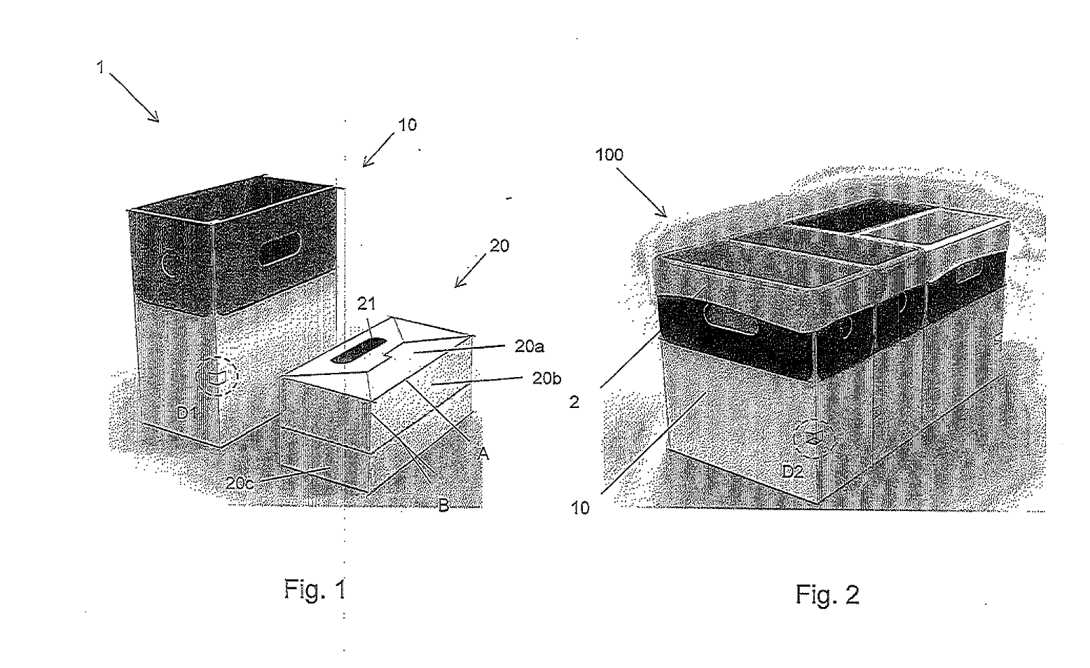

FIG. 1 is a perspective view of a first embodiment of the outer housing and the insert side by side;

FIG. 2 illustrates a plurality of containers provided with waste bags placed side by side;

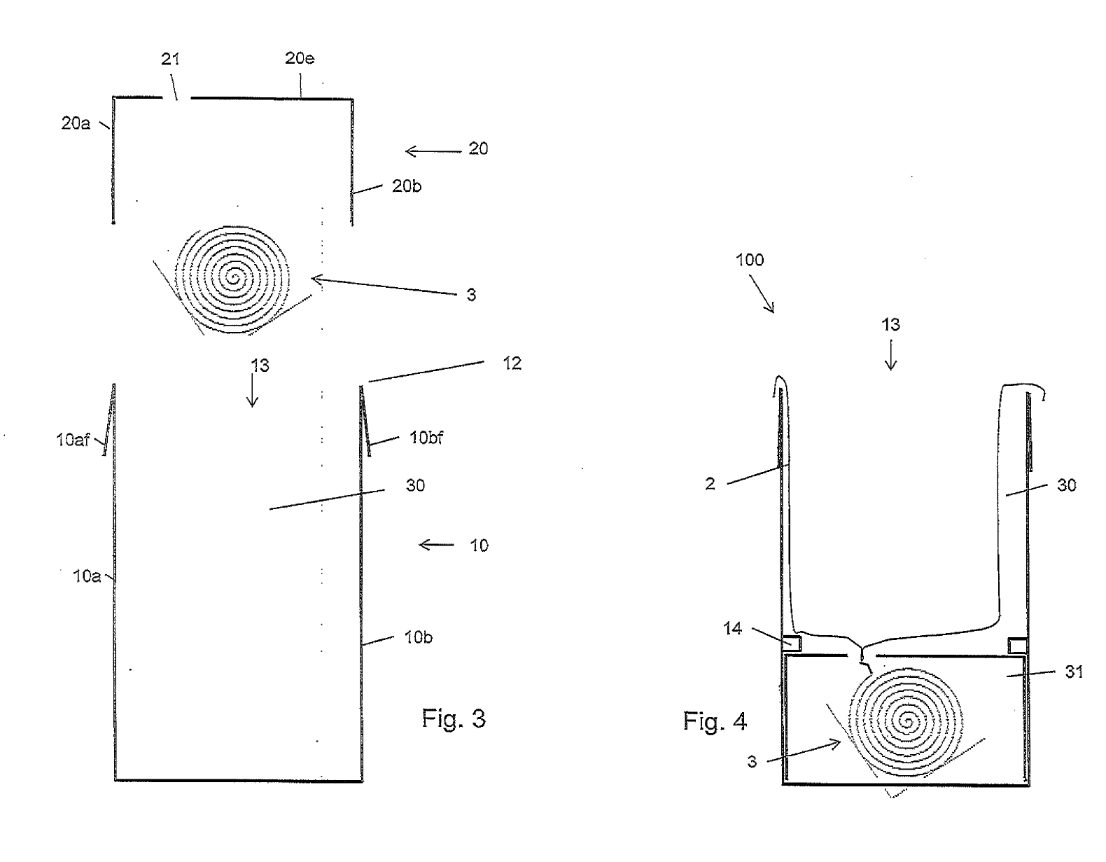

FIG. 3 is a cross-sectional view of the first embodiment of the outer housing, the insert and a roll of waste bags during assembly;

FIG. 4 corresponds to FIG. 3 completely erected;

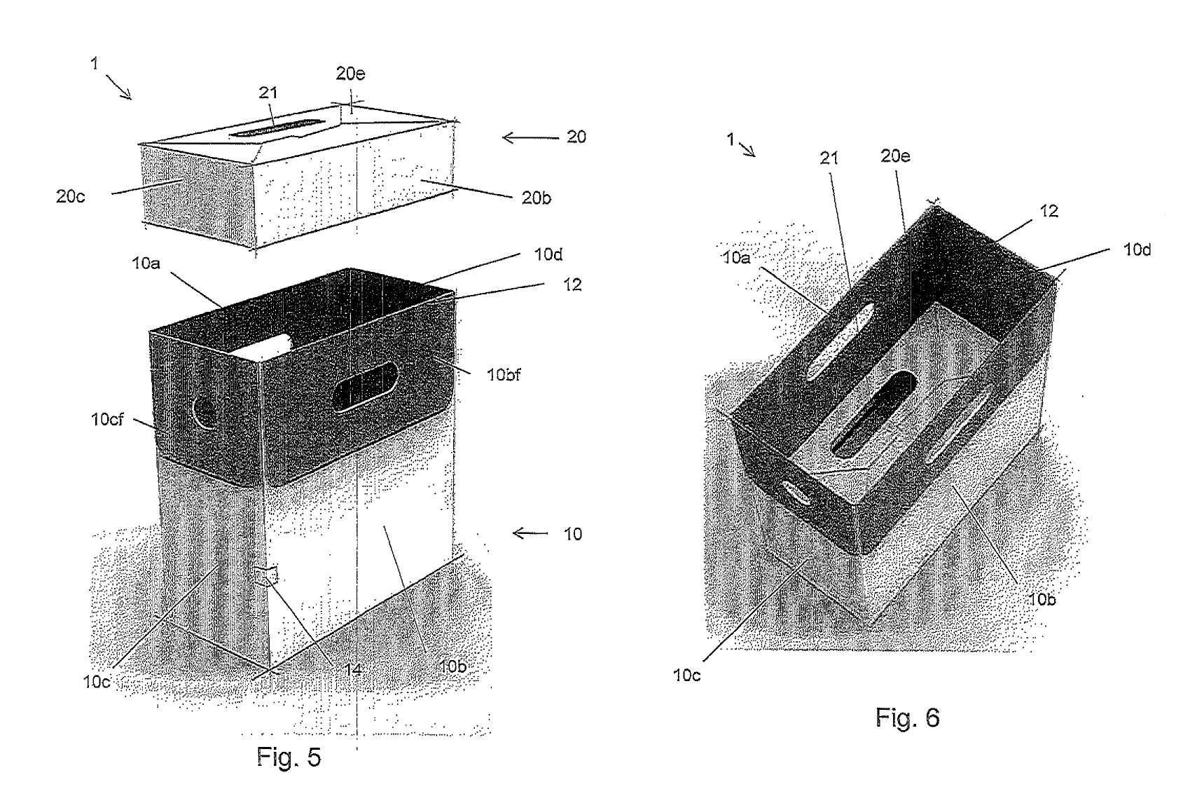

FIG. 5 is a perspective view showing how the insert is put into the outer housing;

FIG. 6 is a top perspective view showing how the insert is put into the outer housing;

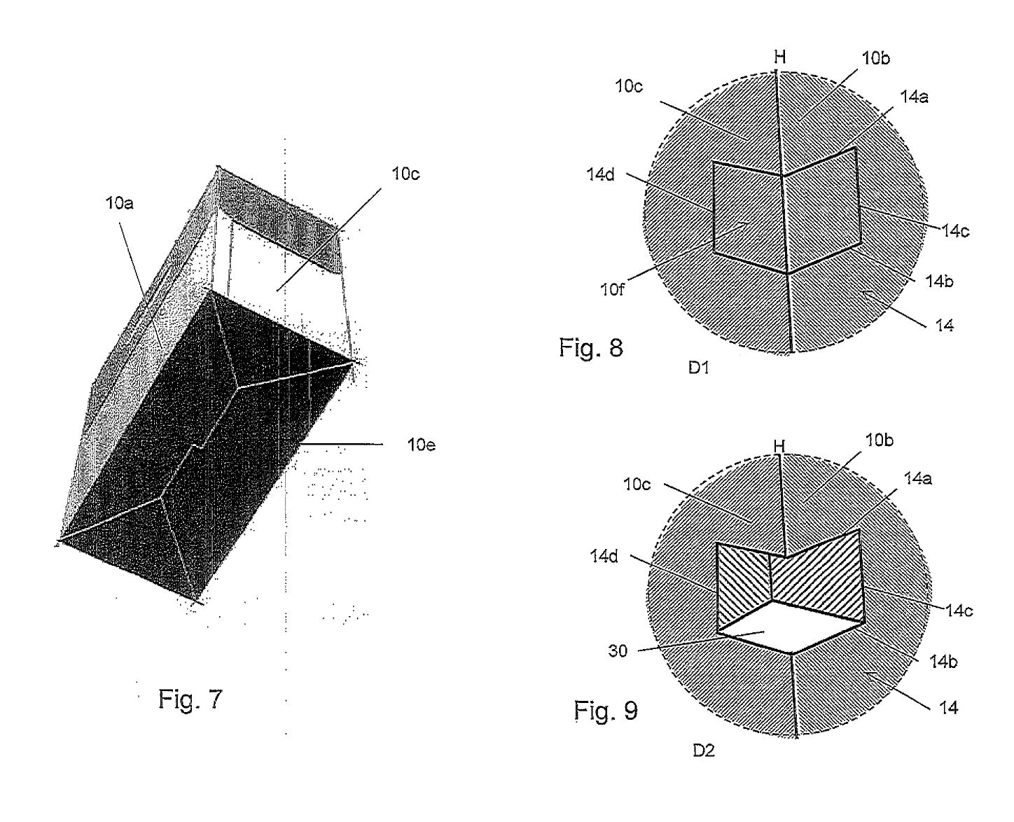

FIG. 7 is a bottom perspective view of the outer housing;

FIG. 8 is an enlarged view of detail D1 from FIG. 1;

FIG. 9 is an enlarged view of detail D2 from FIG. 2;

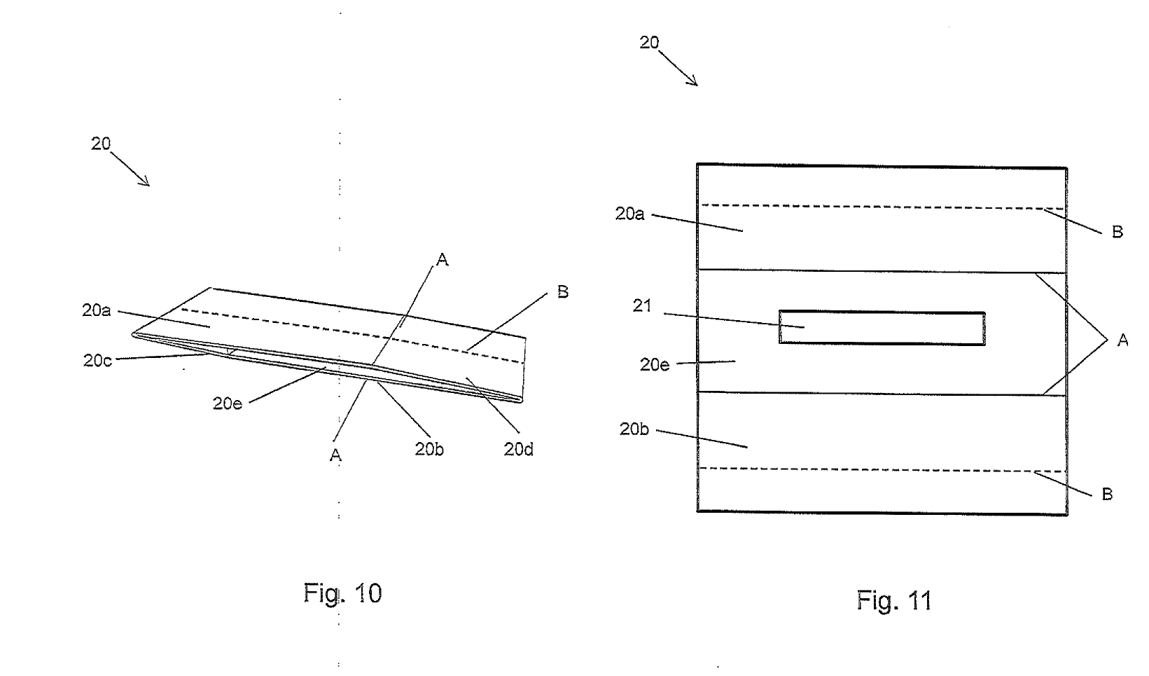

FIG. 10 is a perspective illustration of a first embodiment of the insert in flat-packed state;

FIG. 11 is a top illustration of a second embodiment of the insert in flat-packed state;

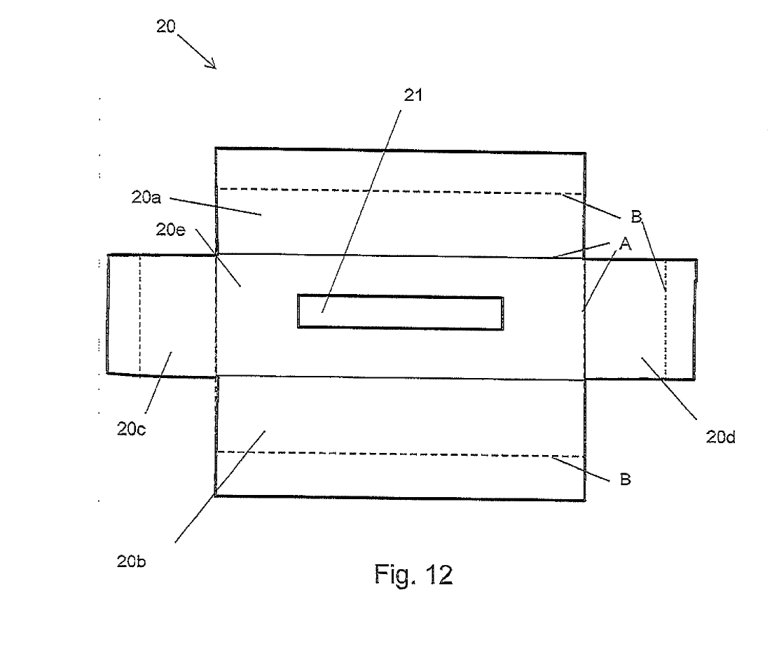

FIG. 12 is a top illustration of a third embodiment of the insert in flat-packed state;

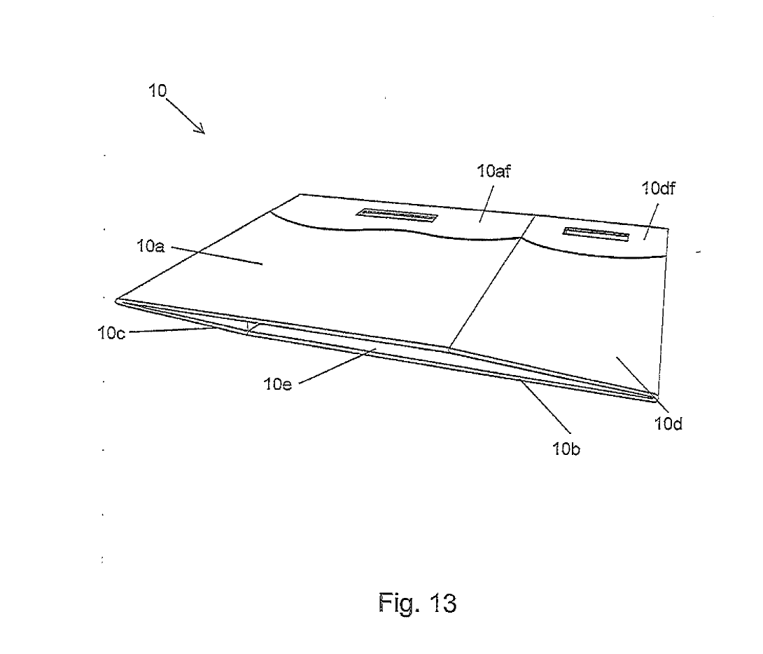

FIG. 13 is a top illustration of the first embodiment of the outer housing in flat-packed state.

Reference is now made to FIGS. 1, 5 and 6. These figures show a waste container 1 for supporting a waste bag 2 (shown in FIG. 2). The container 1 has a flat-packed state and an erected state. This means to say that the container 1 can be erected from its flat-packed stated into its erected state and then be packed flat from its erected state to its flat-packed state again. This is an operation that is preferably carried out without the use of tools or other aids. This makes the handling of a large number of containers efficient during transport and distribution. Preferably, the container 1 is made of paperboard, cardboard, plastic or other suitable material, preferably a recyclable material. Thus, the container 1 can be packed flat after use (for example, if it has been damaged/soiled etc.) and disposed of along with other recyclable material. The waste container 1 may, of course, also be made of a combination of different materials, preferably recyclable materials. The waste container 1 can, for example, be made partly of cardboard or paperboard and partly of a plastic material.

The container 1 will first be described in its erected state. Here, the container 1 comprises an outer housing 10 and an insert 20.

The outer housing 10 comprises walls 10a, 10b, 10c, 10d and a bottom 10e. An upper end 11 of the outer housing 10 comprises an upper edge 12 that forms a top opening 13 of an upper compartment 30. A waste bag can be folded over the edge 12 as shown in FIG. 2 so that the waste bag is held with its opening spread apart, thereby making it easy to put waste in the waste bag. The major part of the waste bag thus lies inside the upper compartment 30 of the housing 10.

The present embodiment of the housing 10, in its erected state, has the form of a rectangular prism with a closed bottom (bottom 10e) and an open top (opening 13).

The insert 20 is provided for placing inside the outer housing 10, and this will be described in more detail below. The insert 20 comprises at least two spacers 20a, 20b and a top 20e, the spacers 20a, 20b projecting downward at right angles from the top 20a. In FIGS. 1, 5 and 6, it is shown that the insert 20 comprises four spacers 20a, 20b, 20c, 20d. The insert 20 further comprises a slot 21 located in the top 20e.

Reference is now made to FIGS. 3 and 4. In FIG. 3 the container 1 is partly erected, whilst in FIG. 4 it is completely erected. In FIG. 3 the outer housing 10 is positioned with the opening 13 facing upwards. A roll 3 of waste bags is then positioned over the opening 13 and then put into the housing 10. The insert 20, with the spacers 20a, 20b projecting downward at right angles from the top (20a) and facing towards the bottom (10a), is subsequently slipped down into the outer housing 10 in such a way that the spacers 20a, 20b meet the bottom 10e. The spacers cause the top 20a to be held at a distance above the bottom 10e, thereby forming a lower compartment 31 in which the waste bag roll 3 is placed.

The outermost bag 2 on the waste bag roll 3 can then be pulled up through the slot 21 and folded over the edge 12 of the outer housing 10. When the bag 2 is full it can be tied together and lifted up, and will thereby draw with it the next bag from the waste bag roll.

The outer housing 10 further comprises a locking means 14 for locking the insert 20 inside the housing 10. The locking means 14 is shown as details D1 and D2 in FIGS. 1 and 2, and these are enlarged in FIGS. 8 and 9. In this embodiment, the locking means 14 comprises two parallel cuts 14a, 14b in a corner H between two walls 10c, 10b, where an area 10f formed by the walls 10c, 10b between the cuts 14a, 14b is pressable into the upper compartment 30, as shown in FIG. 9. The area 10f is pressed into the upper compartment 30 after the insert 20 has been put into the outer housing 10. The locking means 14 is placed at a distance above the bottom 10e that is longer than the spacers 20a, 20b, such that the locking means 14, when pressed into the outer compartment 30, prevents the insert 20 from being pulled out of the outer housing 10. This is particularly favourable when the waste bag is to be changed, in that it is easier to keep the waste bag roll inside the lower compartment 31.

The container 1 preferably comprises two locking means 14 (at opposite corners) or preferably even four such locking means (one in each corner). The locking means 14 can easily be pushed out again into the position in FIG. 8 when there is a need to pull the insert out in order to put in a new waste bag roll 3.

In the embodiments in FIGS. 3 and 5, it is shown that the walls 10a, 10b, 10c, 10d each comprise a folding extension 10af, 10bf, 10cf, 10df which is foldable down on the outside, alternatively the inside, of the outer housing 10 in the erected state, as is shown in FIG. 3. The folding extensions 10af, 10bf, 10cf, 10df form a reinforcement of the upper edge 12, such that the risk of the outer housing 10 being deformed because of the weight of the waste in the waste bag 2 is reduced.

In what follows, the container 1 will be described in the flat-packed state. Reference is first made to FIG. 13, where the outer housing 10 is shown in the flat-packed state. In this embodiment, the outer housing 10 is provided with an automatic bottom. The term “automatic bottom” is used in connection with a type of cardboard box or possibly a box of a plastic material, with a preglued bottom, where it is necessary only to press the cardboard or plastic box out into its erected state, and where the bottom is then ready formed in the cardboard or plastic box. This means that it is not necessary to use tape/glue or the like when the cardboard or plastic box is to be erected. The outer housing 10 in this case is thus made of paperboard, cardboard, plastic or the like with fold lines A.

Embodiments of the insert 20 in the flat-packed state are shown in FIGS. 10, 11 and 12. In the embodiment shown in FIG. 10, the insert 20 is provided with an automatic bottom, as described above in connection with the outer housing in FIG. 13. The insert in this case is made of paperboard, cardboard, plastic or the like with fold lines A and tear lines B, for tearing off the spacers 20. This may be relevant if it is desired to make the container 1 in different sizes, for example, of different height. It may also be relevant if it is desired to have different levels for the insert in containers of the same height, because of different amounts and needs of the different types of waste.

In FIG. 11, the insert 20 comprises a flat piece of cardboard, or a flat piece of plastic material with fold lines A and tear lines B, as described above. The insert here comprises two spacers 20a and 20b. On erection, the flat piece of cardboard or plastic material is folded along fold lines A such that the spacers are oriented at right angles downward, as shown in FIG. 3.

In FIG. 12 the insert 20 also comprises a flat piece of cardboard or a flat piece of plastic material with fold lines A and tear lines B, as described above. The insert in this figure comprises four spacers 20a, 20b, 20c and 20d. On erection, the flat piece of cardboard or plastic material is folded along fold lines A such that the spacers are oriented at right angles downward, as shown in FIG. 3.

In the embodiments in FIGS. 11 and 12, too, parts of the spacers can be torn along tear lines B.

In FIG. 2 and FIG. 4, a system 100 is shown for storing waste, comprising a waste container 1 as described above and a waste bag roll 3 placed in the lower compartment 31 when the waste container is in its erected state. An outermost waste bag 2 on the waste bag roll 3 is provided through the slot 21 in the top 20e of the insert 20 and is further folded over the edge 12 of the outer housing 10.

1. A waste container for supporting a waste bag, wherein the container has a flat-packed state and an erected state, the container in the erected state comprising:
an outer housing comprising walls and a bottom, where an upper end of the outer housing comprises an upper edge that forms a top opening of an upper compartment; and
an insert for placing inside the outer housing, the insert comprising at least two spacers and a top, the spacers projecting downward at right angles from the top towards the bottom such that the spacers cause the top to be held at a distance above the bottom, thereby forming a lower compartment;
wherein the outer housing comprises a locking means for locking the insert inside the housing,
wherein the insert comprises a slot located in the top, wherein the spacers comprise perforated tear lines for tearing off parts of the spacers, and wherein the walls each comprise a foldable extension that is folded down on an outside of the outer housing in the erected state for reinforcement of the upper edge.

2. The container according to claim 1, wherein the top and the spacers in the flat-packed state are provided as a flat cardboard sheet or a flat plastic sheet, the spacers being foldable with the aid of fold lines in the cardboard or plastic sheet.

3. The container according to claim 1, wherein the top and the spacers in the flat-packed state are provided as a box with an automatic bottom.

4. (canceled)

5. The container according to claim 1, wherein the outer housing in the erected state has the form of a rectangular prism and which in the flat-packed state is provided with an automatic bottom.

6. The container according to claim 1, wherein the locking means comprises two parallel cuts in a corner between two walls, where an area formed by the walls between the cuts is pressable into the upper compartment.

7. (canceled)

8. The container according to claim 1, wherein the spacers cause the top to be held substantially parallel to the bottom.

9. A system for storing waste, comprising:
a waste container for supporting a waste bag, wherein the container has a flat-packed state and an erected state, the container in the erected state comprising:
an outer housing comprising walls and a bottom, where an upper end of the outer housing comprises an upper edge that forms a top opening of an upper compartment; and
an insert for placing inside the outer housing, the insert comprising at least two spacers and a top, the spacers projecting downward at right angles from the top towards the bottom such that the spacers cause the top to be held at a distance above the bottom, thereby forming a lower compartment,
wherein the outer housing comprises a locking means for locking the insert inside the housing,
wherein the insert comprises a slot located in the top,
wherein the spacers comprise perforated tear lines for tearing off parts of the spacers, and
wherein the walls each comprise a foldable extension that is folded down on an outside of the outer housing in the erected state for reinforcement of the upper edge; and
a waste bag roll located in the lower compartment when the waste container is in the erected state, where an outermost waste bag of the waste bag roll is provided through the slot in the top of the insert and further is folded over the upper edge of the outer housing.
